(19) United States
(12) Patent Application Publication
(10) Pub. No.: US 2020/0109631 A1
(43) Pub. Date: Apr. 9, 2020

(54) WINDAGE SHIELD SYSTEM FOR A GAS TURBINE ENGINE

(71) Applicant: ROLLS-ROYCE plc, London (GB)

(72) Inventor: Clive BREEN, Derby (GB)

(73) Assignee: ROLLS-ROYCE plc, London (GB)

(21) Appl. No.: 16/570,001

(22) Filed: Sep. 13, 2019

(30) Foreign Application Priority Data
Oct. 5, 2018 (GB) 1816260.2

(51) Int. Cl. F01D 5/02; F04D 29/66

(52) U.S. Cl. CPC F01D 5/027; F05D 2260/15; F05D 2220/36; F04D 29/662

(57) ABSTRACT

A windage shield system comprises first and second hollow cylindrical elements, the longitudinal axes of the outer and inner surfaces of each element being parallel and mutually displaced. The elements are mounted to the downstream end of a fan disc such that the longitudinal axes of the inner surface of the first element and the outer surface of the second element coincide with the rotational axis of the disc. The centres of mass of the elements are mountable with azimuthal offsets ϕ₁, ϕ₂ with respect to the fan disc, each being selectable from a large number of values in the range 0° to 360°. The first element is integral with a windage shield. The system allows a fan disc to be provided with a windage shield and the resulting assembly to be balanced at its rear plane in cases where access to the rear of the fan disc is difficult.

### CROSS-REFERENCE TO RELATED PATENT APPLICATIONS

This application is based upon and claims the benefit of priority from UK Patent Application No. GB1816260.2, filed on Oct. 5, 2018, the entire contents of which are incorporated herein by reference.

### BACKGROUND

### Technical Field

Examples of windage shield systems for a gas turbine engine, such as a geared turbofan engine, are disclosed.

### Description of Related Art

Balancing of the fan disc of a gas turbine engine is typically achieved by application of balancing weights at or near the front and rear planes of the fan disc at positions radially inward of the fan disc. In some gas turbine engines, for example certain geared turbofan engines, access to the rear plane of the fan disc at such positions may be difficult or impossible, and/or there may be no suitable locations for applying balancing weights to achieve rear plane balancing.

### SUMMARY

According to an example, a windage shield system for a fan disc of a gas turbine engine, comprises first and second elements each being mountable directly or indirectly to the fan disc in any one of a plurality of possible orientations with respect to the fan disc such that in a plane normal to the rotation axis of the fan disc the centre of mass of the element occupies one of a corresponding plurality of positions with respect to the fan disc, each being the same distance from the rotation axis of the fan disc.

By providing the functionality of windage shielding and rear-plane balancing within a single arrangement, the system allows for rear-plane balancing of a fan disc in cases where access to the downstream end of the fan disc of an engine is difficult or impossible, thus precluding the use of balancing weights.

Each element may be a hollow cylinder having cylindrical outer and inner surfaces the longitudinal axes of which are parallel and mutually displaced, each element being adapted to be mounted to the fan disc with its longitudinal axes parallel to the rotation axis of the fan disc.

The internal diameter of the first element may be greater than or equal to the external diameter of the second element, the first and second elements being adapted to be mounted to the fan disc such that the longitudinal axes of the inner surface of the first element and the outer surface of the second element coincide with the rotation axis of the fan disc.

In order to provide a compact system, preferably the first and second elements are adapted to be mounted to the fan disc such that the second element lies radially and axially within the first element.

In order to allow the first and second elements to be configured to have zero total unbalance if required, preferably the magnitude of the unbalance of the first element with respect to the longitudinal axis of its inner surface is equal to the magnitude of the unbalance of the second element with respect to the longitudinal axis of its outer surface.

Preferably, the centre of mass of all parts of the system other than the first and second elements lies either on the longitudinal axis of the internal surface of the first element or on the longitudinal axis of the outer surface of the second element. The unbalance of the windage shield system is then entirely determined by the extent to which the first and second elements are mutually azimuthally offset when the system is mounted to a fan disc and the total unbalance of the system may be set to zero in cases where the fan disc has zero unbalance.

For each element the ratio l/d of its length l to its external diameter d if preferably in the range 0.01≤(l/d)≤0.1 in order to provide an axially compact system.

The windage shield of the system may be integral with either the first element or the second element.

According to an example, a method of forming a fan disc assembly for a gas turbine engine, the fan disc assembly comprising a fan disc and a windage shield, comprises the steps of mounting a windage shield system according to an example to the fan disc and adjusting the azimuthal positions of the centres of mass of the first and second elements with respect to the rotation axis of the fan disc such that the magnitude of the total unbalance of the fan disc assembly is less than the unbalance of the fan disc alone, and preferably such that the total unbalance of the fan disc assembly is minimised and more preferably equal to zero.

Except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### DESCRIPTION OF THE DRAWINGS

Embodiments are described below by way of example only, with reference to the figures in which:

FIG. 1 is a longitudinal section of a known, geared, gas turbine engine;

FIG. 2 is a detailed longitudinal section of an upstream portion of the FIG. 1 engine;

FIG. 3 is a longitudinal section of the fan disc of the engine of FIGS. 1 and 2 and a windage shield fitted to the fan disc;

FIG. 4 is a longitudinal section of a fan disc fitted with a windage shield system according to an example;

FIG. 5 shows a transverse section of a component part of the windage shield system of FIG. 4;

FIG. 6 shows a transverse section of another component part of the windage shield system of FIG. 4;

FIG. 7 shows a transverse section of the windage shield system of FIG. 4;

FIG. 8 shows another longitudinal section of the fan disc and windage shield system of FIG. 4;

FIG. 9 shows a transverse section of the windage shield system in which the component parts shown in FIG. 7 have a first mutual azimuthal offset;

FIG. 10 indicates the positions of the centres of mass of the component parts shown in FIG. 9;

FIG. 11 indicates the unbalances of the component parts shown in FIG. 9;

FIG. 12 shows a transverse section of the windage shield system in which the component parts shown in FIG. 7 have a second mutual azimuthal offset;

FIG. 13 indicates the unbalances of the component parts shown in FIG. 12;

FIG. 14 shows a transverse section of the windage shield system in which the component parts shown in FIG. 7 have a third mutual azimuthal offset; and

FIG. 15 indicates the unbalances of the component parts shown in FIG. 14.

### DETAILED DESCRIPTION

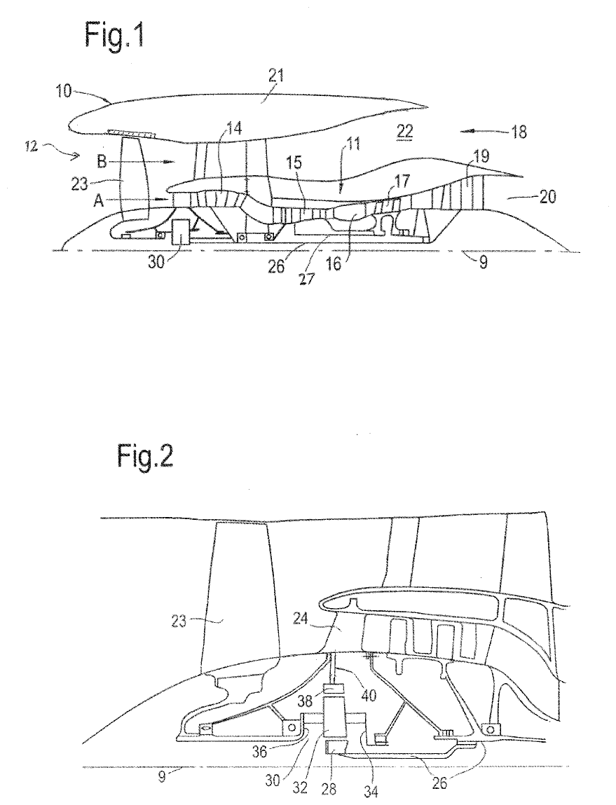

FIG. 1 illustrates a gas turbine engine 10 having a principal rotational axis 9. The engine 10 comprises an air intake 12 and a propulsive fan 23 that generates two airflows: a core airflow A and a bypass airflow B. The gas turbine engine 10 comprises a core 11 that receives the core airflow A. The engine core 11 comprises, in axial flow series, a low pressure compressor 14, a high-pressure compressor 15, combustion equipment 16, a high-pressure turbine 17, a low pressure turbine 19 and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclic gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the nozzle 20 to provide some propulsive thrust. The high pressure turbine 17 drives the high pressure compressor 15 by a suitable interconnecting shaft 27. The fan 23 generally provides the majority of the propulsive thrust. The epicyclic gearbox 30 is a reduction gearbox.

An exemplary arrangement for the geared fan gas turbine engine 10 is shown in FIG. 2. The low pressure turbine 19 (see FIG. 1) drives the shaft 26, which is coupled to a sun wheel, or sun gear, 28 of the epicyclic gear arrangement 30. Radially outwardly of the sun gear 28 and intermeshing therewith is a plurality of planet gears 32 that are coupled together by a planet carrier 34. The planet carrier 34 constrains the planet gears 32 to precess around the sun gear 28 in synchronicity whilst enabling each planet gear 32 to rotate about its own axis. The planet carrier 34 is coupled via linkages 36 to the fan 23 in order to drive its rotation about the engine axis 9. Radially outwardly of the planet gears 32 and intermeshing therewith is an annulus or ring gear 38 that is coupled, via linkages 40, to a stationary supporting structure 24.

Note that the terms “low pressure turbine” and “low pressure compressor” as used herein may be taken to mean the lowest pressure turbine stages and lowest pressure compressor stages (i.e. not including the fan 23) respectively and/or the turbine and compressor stages that are connected together by the interconnecting shaft 26 with the lowest rotational speed in the engine (i.e. not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

It will be appreciated that the arrangement shown in FIGS. 1 and 2 is by way of example only, and various alternatives are within the scope of the present disclosure. Purely by way of example, any suitable arrangement may be used for locating the gearbox 30 in the engine 10 and/or for connecting the gearbox 30 to the engine 10. By way of further example, the connections (such as the linkages 36, 40 in the FIG. 2 example) between the gearbox 30 and other parts of the engine 10 (such as the input shaft 26, the output shaft and the fixed structure 24) may have any desired degree of stiffness or flexibility. By way of further example, any suitable arrangement of the bearings between rotating and stationary parts of the engine (for example between the input and output shafts from the gearbox and the fixed structures, such as the gearbox casing) may be used, and the disclosure is not limited to the exemplary arrangement of FIG. 2. For example, where the gearbox 30 has a star arrangement (described above), the skilled person would readily understand that the arrangement of output and support linkages and bearing locations would typically be different to that shown by way of example in FIG. 2.

Accordingly, the present disclosure extends to a gas turbine engine having any arrangement of gearbox styles (for example star or planetary), support structures, input and output shaft arrangement, and bearing locations.

Optionally, the gearbox may drive additional and/or alternative components (e.g. the intermediate pressure compressor and/or a booster compressor).

Other gas turbine engines to which the present disclosure may be applied may have alternative configurations. For example, such engines may have an alternative number of compressors and/or turbines and/or an alternative number of interconnecting shafts. By way of further example, the gas turbine engine shown in FIG. 1 has a split flow nozzle 18, 20 meaning that the flow through the bypass duct 22 has its own nozzle that is separate to and radially outside the core engine nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area.

Although the described example relates to a turbofan engine, the disclosure may apply to any type of gas turbine engine, such as for example a gas turbine engine having an open rotor (in which the fan stage is not surrounded by a nacelle) or a turboprop engine, either with or without a gearbox.

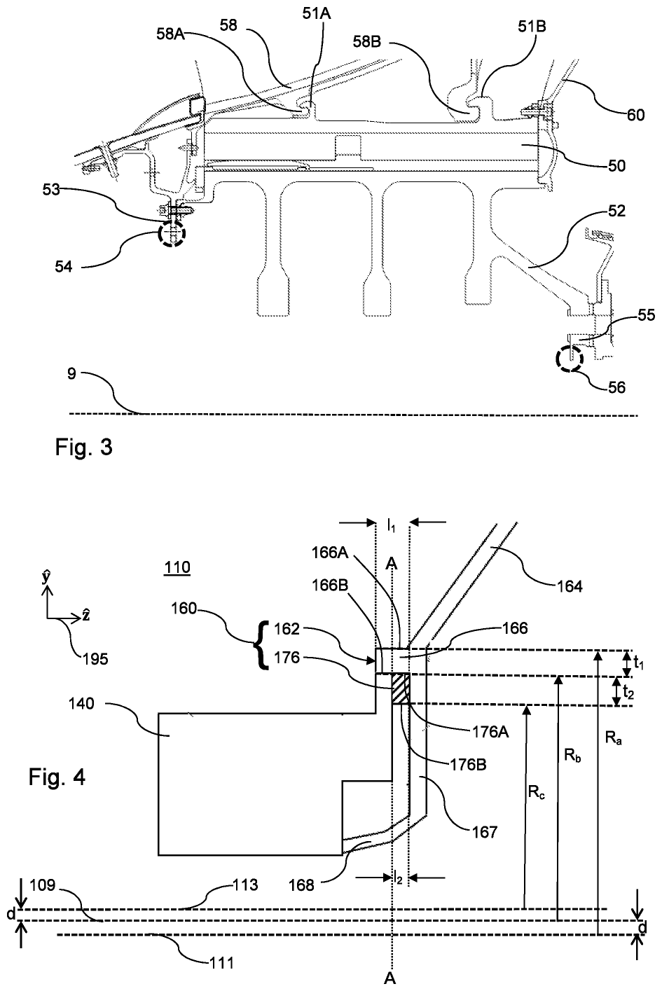

FIG. 3 shows a longitudinal section of the gas turbine engine 10 in the vicinity of the fan disc 50 of the engine 10 in a plane passing through the principal rotational axis 9 of the engine 10 (only structure on a single side of the principal rotational axis 9 of the engine 10 is shown). Fan blades (not shown) of the engine 10 are mounted in slots in the fan disc 50 which extend parallel to the axis 9. The low pressure shaft of the engine 10 is coupled to the fan disc 50 by a drive arm 52 which extends from the downstream end of the fan disc 50 in the downstream direction, i.e. the drive arm 52 is rearward-facing. This arrangement allows balancing weights to be applied at locations 54, 56 in order to balance the fan disc 50 (including the fan blades) at planes at or near the front and rear of the fan disc 50, the locations 54, 56 being at the inner diameters of a support ring 53 and a curvic joint 55 respectively and disposed radially inwardly of the inner surface of the fan disc 50. A windage shield 60 is attached to the downstream end of the fan disc 60 to prevent movement of air from positions downstream of the windage shield 60 forwards to the region of the fan disc 50 during operation of the engine 10. The fan disc 50 has a series of pairs of annulus filler fixings, such as 51A, 51B on its external surface at a corresponding series of circumferential positions. Each pair of fixings 51A, 51B holds an annulus filler, such as 58, between an adjacent pair of fan blades by engagement with a corresponding pair of fixings, such as 58A, 58B on the annulus filler.

In some gas turbine engines the presence of structure near the downstream end of the fan disc of the engine obstructs access to that end of the fan disc at positions radially inward of the fan disc and it is therefore difficult or impossible to apply balancing weights in positions such as 56 in FIG. 3, precluding rear-plane balancing of the fan disc. For example in a geared gas turbine engine, such as a geared turbofan engine, structure related to the gearbox may obstruct access to the rear of the fan disc. In some geared engines, gearbox-related structure is accommodated by use of a forward-facing drive arm which extends forward of the fan disc and connects with the low pressure shaft of the engine upstream of the fan disc, the low pressure shaft extending completely through the interior of the fan disc. Although this may better accommodate the gearbox-related structure, such an arrangement eliminates a rearward-facing drive arm and a coupling point between such an arm and the low pressure shaft of the engine (such as the curvic joint 55 in FIG. 3), and hence also a location for application of weights to achieve rear-plane balancing of the fan disc. In this and similar cases an alternative way to achieve rear plane balancing of the fan disc is required.

FIG. 4 shows a longitudinal section of a fan disc 140 fitted with a windage shield system 160 according to an example, the section being in a plane passing through the principal rotational axis 109 of an engine of which the fan disc 140 and windage shield system 160 form part. Coordinate axes 195 fixed in relation to the fan disc 140 define a positive z direction parallel to the axis 109 in the general direction of airflow through the engine. The positive y direction is normal to the axis 109 and in the plane of FIG. 4. The positive x direction is defined by \hat{x}=ŷ×\hat{z}. (Bold type denotes a vector; roof accents denote unit vectors.) The windage shield system 160 is made up of first and second parts 162, 176. The first part 162 comprises a windage shield 164 formed integrally with an annular supporting disc 167 having a forwardly-extending cylindrical arm 168, and a first, hollow cylindrical element 166 having cylindrical outer and inner surfaces 166A, 166B and a mass m₁. The longitudinal axes of the surfaces 166A, 166B are mutually parallel and offset by a displacement d; that of inner surface 166B coincides with the principal rotational axis 109 of the engine and that of the outer surface 166A is indicated by 111. The outer and inner surfaces 166A, 166B of the first, hollow cylindrical element 166 have radii Rₐ, R_{b} respectively. In FIG. 4 the first, hollow cylindrical element 166 is shown as having an appreciable length l₁ parallel to the axis 109, however the length l₁ of the element 166 may be very short compared to its external diameter 2Rₐ, thus providing an axially-compact arrangement together with the second part 176 and the fan disc 140. The ratio of the length l₁ of the first hollow, cylindrical element 166 to its external diameter 2Rₐ may be in the range 0.01<(l₁/2Rₐ)<0.1 for example. The first part 162 of the windage shield system 160 is attached to the fan disc 140 at a forward end of the cylindrical arm 168 and the forward terminal end of the first, hollow cylindrical element 166. The disc 167, including the arm 168, and windage shield 164 have a cylindrically symmetric mass distribution with respect to the principal rotational axis 109 of the engine so that the centre of mass of these elements lies on the axis 109. The first part 162 may be attached to the fan disc 140 in any one of a number of orientations with respect to the fan disc 140 such that the first part 162 and fan disc 140 are mutually offset in azimuth about the axis 109 by any one of a number of possible angles in the range 0° to 360°. In other words, an arbitrary point on the outer cylindrical surface of the fan disc 140 and an arbitrary point on the outer cylindrical surface 166A of the first hollow cylindrical element 166 of the first part 162 may be mutually offset in azimuth by an angle which may have any one of a large number of possible values.

The second part of the windage shield system 160 is a second hollow, cylindrical element 176 of mass m₂ having outer 176A and inner 176B cylindrical surfaces of radius R_{b}, R_{c} respectively. The longitudinal axes of the outer and inner surfaces 176A, 176B of the second, hollow cylindrical element 176 are mutually parallel and offset by a displacement d. The longitudinal axis of the outer surface 176A coincides with the principal rotation axis 109; that of the inner surface 176B is indicated by 113. The second part 176 may be directly or indirectly attached to the fan disc 140 in any one of a number of orientations such that the second part 176 and the fan disc 140 are mutually offset in azimuth about the axis 109 by any one of a number of possible angles in the range 0° to 360°. In other words, an arbitrary point on the outer cylindrical surface of the fan disc 140 and an arbitrary point on the outer cylindrical surface 176A of the second part 176 may be offset in azimuth by an angle which may have any one of a large number of possible values. The second part 176 has the form of a short cylinder of axial length l₂<l₁ and may be essentially laminar in some variants of the windage shield system 160.

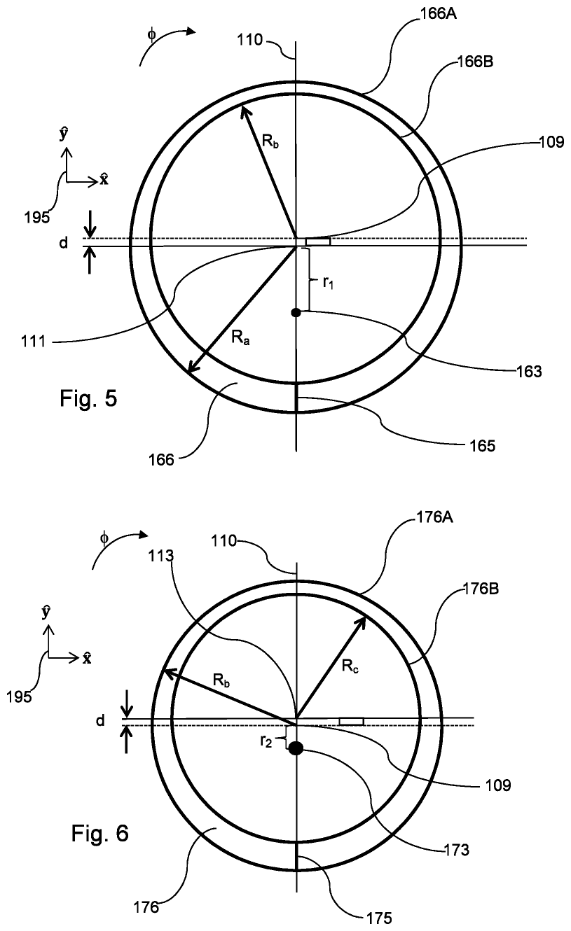

FIGS. 5 and 6 show transverse sections of the first and second hollow, cylindrical elements 166, 176 respectively in a plane A-A indicated in FIG. 4, perpendicular to axes 109, 111, 113, with the elements 166, 176 having the same azimuthal orientation with respect to the axis 109 as they have in FIG. 4. The transverse sections of the elements 166, 176 each have the general form of an annulus, the radial thickness of which varies with azimuthal position ϕ about the principal rotational axis 109. The azimuthal positions at which the annuli have their greatest radial thicknesses are indicated by lines 165, 175 respectively. Thus in FIGS. 5 and 6, lines 165, 175 each coincide with the −ŷ direction. Axis 110 corresponds to the plane of FIG. 4 and these azimuthal positions, and passes through the principal rotational axis 109. The wall thicknesses of cylindrical elements 166, 176 in the xy plane thus vary with azimuthal position ϕ about the axis 109. With the elements 166, 176 having the azimuthal orientation shown in FIGS. 5 and 6, the elements 166, 176 are symmetrical about a plane which includes the axis 110 and which is perpendicular to the plane of FIGS. 5 and 6. The centres of mass 163, 173 of the elements 166, 176 in the plane of FIGS. 5 and 6 lie on the axis 110 and are displaced from the position of the axis 109 in directions towards the widest parts 165, 175 of the annuli by distances r₁, r₂ respectively, i.e. they are displaced from the axis 109 in the −ŷ direction. The magnitudes u₁, u₂ of the unbalances u₁, u₂ of the first and second elements 166, 176 are therefore u₁=m₁r₁ and u₂=m₂r₂ respectively.

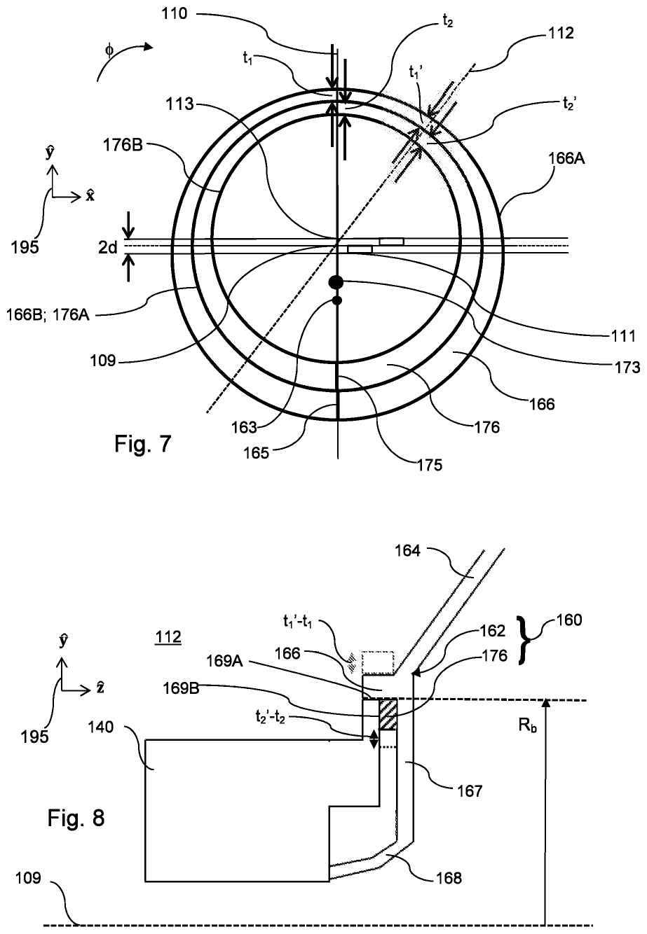

FIG. 7 shows a transverse section through the first and second hollow, cylindrical elements 166, 176, with the second element 176 nested inside the first element 166, as they are installed on the fan disc 140 as shown in FIG. 4, the transverse section being in the plane indicated A-A in FIG. 4. As indicated above, the first 162 and second 164 parts of the windage shield system 160 may each be attached to the fan disc 140 with any desired orientation with respect to the fan disc 140, or at least any one of a large number of possible orientations in the range 0° to 360°. The positions r₁, r₂ of the centres of mass of the elements 166, 176 with respect to the axis 109 in the plane A-A may therefore be varied although the magnitudes r₁, r₂ are fixed. In the configuration shown in FIG. 7, r₁=−r₁ŷ and r₂=−r₂ŷ so that u₁=−u₁ŷ=−m₁r₁ŷ and u₂=−u₂ŷ=−m₂r₂ŷ. The total unbalance U is therefore U=−(u₁+u₂)ŷ. In general, the first 162 and second 176 parts of the windage shield system 160 may be attached to the fan disc 140 with azimuthal offsets ϕ₁, ϕ₂ respectively with respect to the x axis of the fan disc 140, i.e. cos ϕ₁=\hat{x}. \hat{r}₁, cos ϕ₂=\hat{x}. \hat{r}₂, and with a mutual azimuthal offset ε=ϕ₁−ϕ₂ between position vectors r₁, r₂ of the centres of mass of the elements 166, 176. In the arrangement of the elements 166, 176 shown in FIG. 7, ϕ₁=ϕ₂=−90° and ε=0°.

As depicted in FIGS. 4 and 7, the first 162 and second 176 parts of the windage shield system 160 are installed on the fan disc 140 with orientations such that the positions 165, 175 of the thickest parts of the walls of the first and second hollow, cylindrical elements 166, 176 are azimuthally aligned. The positions of the thinnest parts of the walls of the elements 166, 176 are diametrically opposite the positions 165, 175; the wall thicknesses of the elements 166, 176 at these positions are t₁, t₂ respectively.

FIG. 7 shows another axis 112 passing through the rotation axis 109, the axis 112 being offset in azimuth ϕ from the axis 110. FIG. 8 shows another longitudinal section through the fan disc 140 fitted with the windage shield system 160, the plane of the section including the axis 112 and being perpendicular to the plane of FIG. 7. At the azimuthal position corresponding to the axis 112, the wall thicknesses of the first and second hollow, cylindrical elements 166, 176 are t₁′, t₂′ respectively, the increases in wall thickness t₁′-t₁ and t₂′-t₂ compared to the wall thicknesses along the axis 110 being indicated in FIG. 8, which shows a longitudinal section of the fan disc 140 fitted with the windage shield system 160 in a plane through the axis 109 and corresponding to the axis 112.

Since the windage shield system 160 may be attached to the fan disc 140 such that the parts 162, 176 each have any one of a number of possible orientations ϕ₁, ϕ₂ with respect to the x-axis of the fan disc 140, there may be any desired mutual azimuthal offset ε between position vectors r₁, r₂ of the centres of mass of the elements 166, 176. (cos ε= [symbol] . [symbol] .) Since the windage shield 164 and supporting disc 167 (including arm 168) of the first part 162 of the windage shield system 160 each have a symmetrical mass distribution about the axis 109, the total unbalance U of the windage shield system 160 when installed on the fan disc 140 is determined by the masses m₁, m₂ of the elements 166, 176 and their mutual azimuthal offset ε. The total unbalance U of the system 160 is the sum of the individual unbalances u₁=m₁r₁, u₂=m₂r₂ of the first and second elements 166, 176, i.e. U=u₁+u₂. By adjusting the mutual azimuthal offset ε between positions vectors r₁, r₂ of the centres of mass of the two elements 166, 176 the magnitude U of the total unbalance of the windage shield system may be adjusted:

U2=U.U=u₁²+u₂²++2u₁u₂ cos ε.

By adjusting ε the magnitude U of the total unbalance of the windage shield system 160 may therefore be adjusted between values u₁²+u₂²+2u₁u₂ and u₁² u₂²−2u₁u₂. By adjusting the orientation of the windage system 160 as a whole with respect to the fan disc 140, i.e. by adjusting ϕ₁ and ϕ₂ in additional to a, the total unbalance of the fan disc 140 together with the windage shield 160 may be reduced compared to the unbalance of the fan disc 140 alone.

If the masses m₁, m₂ of the elements 166, 176 are such that the magnitudes of the unbalances of the elements are equal, i.e. u₁=m₁r₁=u₂=m₂r₂=u then the magnitude U of the total unbalance of the windage shield system 160 is

U=u√(2(1+cos ε))

and U may be adjusted between the values 0 and 2u by adjusting the mutual azimuthal offset ε of the first and second parts 162, 176 of the windage shield system 160. In this case the windage shield may correct for very small values of unbalance of the fan disc 140, and the unbalance of the system 160 may be set to zero if the fan disc 140 has zero unbalance.

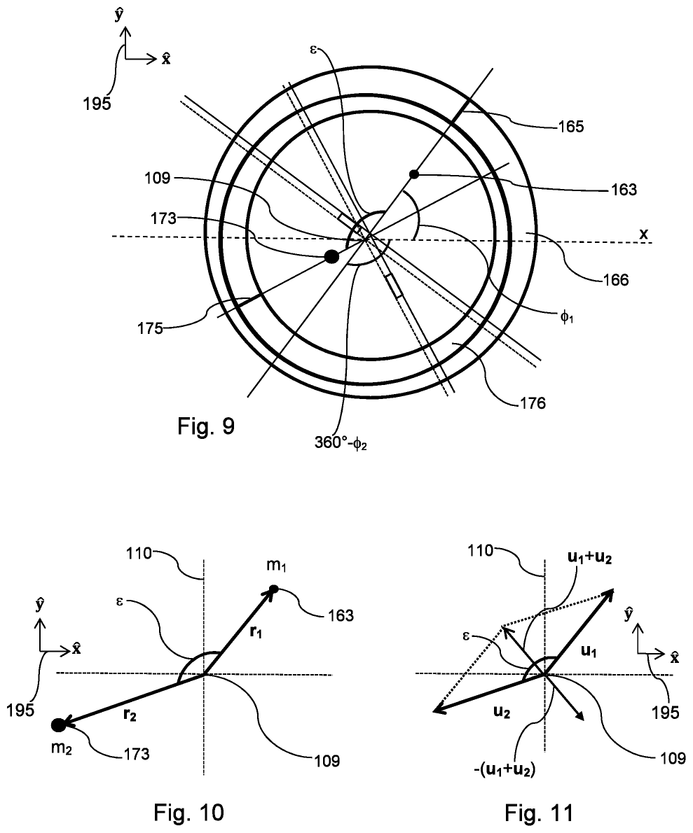

FIG. 9 shows a transverse section through the elements 166, 176 with a mutual azimuthal offset ε between position vectors r₁, r₂ of the centres of mass 163, 173 of the first and second elements 166, 176 in the xy plane. The positions r₁, r₂ of the centres of mass 163, 173 in the xy plane are indicated in FIG. 10. FIG. 11 shows the total unbalance u₁+u₂ of the first and second elements 166, 176 (which is also the total unbalance of the windage shield system 160) where u₁=u₂. An unbalance −(u₁+u₂) of the fan disc 140 may therefore be compensated for when the elements 166, 176 have the configuration shown in FIG. 9.

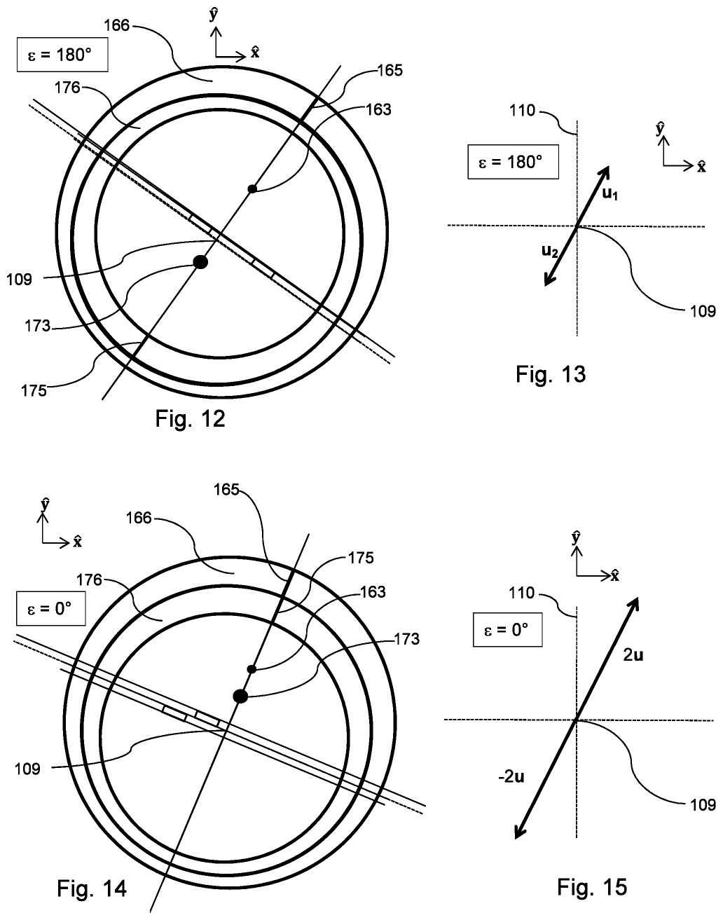

In FIGS. 12 and 13, ε=180° so that if u₁=m₁r₁=u₂=m₂r₂ the unbalances u₁, u₂ of the first and second elements are equal and opposite, i.e. u₁=−u₂. This configuration of the windage shield system 160 may be used if the fan disc 140 does not need balancing, i.e. its centre of mass lies on the rotation axis 109 and the fan disc 140 has zero unbalance.

FIGS. 14 and 15 correspond to a transverse section through the first and second element 166, 176 with ε=0° so that if m₁r₁=m₂r₂=u then u₁=u₂ and the windage shield system 160 has a maximum unbalance of 2u (magnitude 2u) which provides compensation for a maximum compensable unbalance −2u in the fan disc 140.

Referring to FIG. 8, in order to allow part 162 of the windage shield system 160 to be attached to the fan disc 140 with the position 165 and the centre of mass 163 at any one ϕ₁ of a number of azimuthal offsets with respect to the fan disc 140, part 162 may be fixed to the fan disc 140 by a first series of bolts or pins at a radial position indicated by 169A and distributed azimuthally (preferably at regular intervals in azimuth). Similarly, a second such series of bolts or pins at a radial position 169B may be used to join the second part 176 to the fan disc 140 with a desired azimuthal offset ϕ₂ with respect to the fan disc 140. For example if a series of n bolts and corresponding receiving holes in the fan disc 140 are provided at radial position 169B and distributed evenly in azimuth with a first bolt/hole pair on the x axis, each bolt passing through a corresponding hole in the second part 176, then the second part 176 may be bolted to the fan disc 140 such that the position r₂ of the centre of mass 173 of the second part 176 is offset from the \hat{x} direction by any desired angle ϕ₂=(m/n).360° where m=0, 1, 2 . . . (n−1). That is,

ϕ₂=cos⁻¹(\hat{x}. [symbol] )=(m/n).360°. If n is large then the offset angle ϕ₂ is essentially continuously variable in the range 0° to 360°.

If the centre of mass of the windage shield 164 and support disc 167 (including arm 168) do not lie on the longitudinal axis of the inner surface of the first element 166, the elements 166, 176 will need to be adjusted to compensate for the unbalance of these elements in addition to that of the fan disc 140.

Referring again to FIGS. 4 and 8, the second hollow, cylindrical element 176 is located within the first hollow, cylindrical element 166 both axially and radially when the windage shield system 160 is mounted to the fan disc 140, thus providing an axially and radially compact arrangement which may be especially useful in engines where space is limited at the rear of the fan disc of the engine, such as in certain geared engines for example. The windage shield system 160 occupies substantially no more space than is required by a windage shield system of the prior art, especially in examples in which the second hollow cylindrical element 176 has the form of an essentially laminar ring (i.e. its thickness is small compared to its external diameter).

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

### Notation:

$$Vector a ( bold type )$$

$$Modulus or magnitude of vector a = \vert a \vert$$

$$Unit vector in direction of a \hat{a} = \frac{a}{\vert a \vert} = \frac{a}{a}$$

What is claimed is:

1. A windage shield system for a fan disc of a gas turbine engine, the system comprising first and second elements each being mountable directly or indirectly to the fan disc in any one of a plurality of possible orientations with respect to the fan disc such that in a plane normal to the rotation axis of the fan disc the centre of mass of the element occupies one of a corresponding plurality of positions with respect to the fan disc, each being the same distance from the rotation axis of the fan disc.

2. A windage shield system according to claim 1, wherein each element is a hollow cylinder having cylindrical outer and inner surfaces the longitudinal axes of which are parallel and mutually displaced and is adapted to be mounted to the fan disc with its longitudinal axes parallel to the rotation axis of the fan disc.

3. A windage shield system according to claim 2, wherein (a) the internal diameter of the first element is greater than or equal to the external diameter of the second element and (b) the first and second elements are adapted to be mounted to the fan disc such that the longitudinal axes of the inner surface of the first element and the outer surface of the second element coincide with the rotation axis of the fan disc.

4. A windage shield system according to claim 3, wherein the first and second elements are adapted to be mounted to the fan disc such that the second element lies radially and axially within the first element.

5. A windage shield system according to claim 3, wherein the magnitude of the unbalance of the first element with respect to the longitudinal axis of its inner surface is equal to the magnitude of the unbalance of the second element with respect to the longitudinal axis of its outer surface.

6. A windage shield system according to claim 5, wherein the centre of mass of all parts of the system other than the first and second elements lies either on the longitudinal axis of the internal surface of the first element or on the longitudinal axis of the outer surface of the second element.

7. A windage shield system according to claim 2, wherein for each element 0.01≤(l/d)≤0.1 where l and d are respectively the length and external diameter of the element.

8. A windage shield system according to claim 1, and comprising a windage shield integral with the first element.

9. A windage shield according to claim 1, and comprising a windage shield integral with the second element.

10. A method of forming a fan disc assembly for a gas turbine engine, the fan disc assembly comprising a fan disc and a windage shield, the method comprising the steps of mounting a windage shield system according to any preceding claim to the fan disc and adjusting the azimuthal positions of the centres of mass of the first and second elements with respect to the rotation axis of the fan disc such that the magnitude of the total unbalance of the fan disc assembly is less than the unbalance of the fan disc alone.

11. A method according to claim 10, comprising the step of adjusting the azimuthal positions of the centres of mass of the elements with respect to the rotation axis of the fan disc such that the total unbalance of the fan disc assembly is minimised.
